(19) United States
(12) Patent Application Publication
(10) Pub. No.: US 2015/0056837 A1
(43) Pub. Date: Feb. 26, 2015

(54) ELECTRICAL CONNECTOR

(71) Applicant: LOTES CO., LTD, KEELUNG (TW)

(72) Inventor: Zhi Yong Zhou, Guangzhou (CN)

(73) Assignee: LOTES CO., LTD, KEELUNG (TW)

(21) Appl. No.: 14/183,124

(22) Filed: Feb. 18, 2014

(30) Foreign Application Priority Data
Aug. 21, 2013 (CN) 201320509522.5

(51) Int. Cl. H01R 13/629

(52) U.S. Cl. CPC H01R 13/62933
USPC 439/267

(57) ABSTRACT

An electrical connector includes a shell, a conducting base accommodated in the shell in a sliding manner, and a rotatable body having a pivot for pivoting the conducting base. At least one side of the conducting base has a first elastic member. The rotatable body has a bump located below the center of the pivot. The first elastic member is a linear spring and butts the bump. When the conducting base retreats from the shell, the first elastic member butts the bump, the rotatable body rotates and an insertion space is formed between the rotatable body and the conducting base for a mating plug to be inserted therein.

### CROSS-REFERENCE TO RELATED APPLICATION

This non-provisional application claims priority under 35 U.S.C. § 119(a) on Patent Application No. 201320509522.5 filed in P.R. China on Aug. 21, 2013, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates generally to an electrical connector, and more particularly to an electrical connector for a registered jack (RJ) plug to be inserted therein.

### BACKGROUND OF THE INVENTION

An existing opening height adjustable RJ connector mechanism, such as that in Chinese Patent No. CN201220072463.5, has a base body. The outside of the base body is covered and positioned with a shielding shell and a movable base. The base body is provided with a sliding space for the movable base to move to and fro, and positioned with multiple mating terminals. One end of the movable base toward an interface of a mating network cable is combined with a positioning mechanism. The positioning mechanism includes an outer case and a rotatable body. Two sides of the outer case are each provided with a convex column. Each convex column is sleeved with a torsional spring. The rotatable body has a frame and two side boards. The two side boards are each provided with an axle hole capable of being pivoted to the convex column. When the rotatable body is in an opened state, an insertion opening is formed between the rotatable body and the outer case for a mating plug to be inserted therein. Pins at two ends of the torsional spring on the convex column are each elastically supported on a positioning slot on a side wall of the movable base and the frame, so that the rotatable body has an elastic restoration function. When the torsional spring is installed, firstly the torsional spring is sleeved over the convex column, then the pins at the two ends are installed onto the positioning slot of the movable base and the frame respectively, and the pins at the two ends are located at two opposite sides of the torsional spring and have large elasticity, thus the installation process is complex and it is difficult to install. Only if the torsional spring is elastically supported on the positioning slot on the side wall of the movable base and the frame, the rotatable body can have the elastic restoration function. In the installation process, if the torsional spring is installed and deviated, the pins at the two ends cannot be elastically supported on the positioning slot on the side wall of the movable base and the frame, and the rotatable body cannot be elastically restored, resulting in that the movable base cannot smoothly retreat from the sliding space of the base, and the insertion of the mating plug is affected.

Therefore, a heretofore unaddressed need exists in the art to address the aforementioned deficiencies and inadequacies.

### SUMMARY OF THE INVENTION

In one aspect, the present invention is directed to an electrical connector that can be installed easily and is easy to operate.

In one embodiment, an electrical connector for electrically connecting a mating plug includes a shell, a conducting base accommodated in the shell in a sliding manner, and a rotatable body. At least one side of the conducting base is provided with a first elastic member. The rotatable body has at least one side board corresponding to the first elastic member and located at the same side of the conducting base. The side board has a pivot used for being pivoted to the conducting base. One end of the side board has a bump located below the center of the pivot, so that the first elastic member butts the bump. The other end of the side board is horizontally connected to a top board. When the conducting base retreats from the shell, the first elastic member butts the bump, so that the side board rotates relative to the conducting base. The top board is located above the conducting base. An insertion space is formed between the top board and the conducting base for the mating plug to be inserted therein, such that the mating plug is electrically connected to the conducting base.

In one embodiment, two sides of the conducting base are each provided with a sliding slot along a sliding direction, and the pivot slides in the sliding slot.

In one embodiment, the pivot is located at one side of the side board, and the bump is located at the other side of the side board opposite to the one side.

In one embodiment, the pivot is located at one side of the side board, and the bump and the pivot are located at the same side of the side board.

In one embodiment, a base body is accommodated in the shell, at least one second elastic member is installed between the base body and the conducting base, and the second elastic member provides an elastic force enabling the conducting base to retreat from the shell.

In one embodiment, a buckling portion is convexly arranged on the shell, the top board is correspondingly provided with a concave portion, and when the conducting base is located in the shell, the buckling portion buckles the concave portion to fix the rotatable body.

In one embodiment, when the conducting base is located in the shell, the rotatable body and the conducting base are partially superimposed, and the rotatable body is accommodated in the shell.

In one embodiment, when the conducting base is located in the shell, the pivot is located at a first end of the sliding slot, and when the conducting base retreats from the shell and forms the insertion space with the top board, the pivot slides to a second end of the sliding slot.

In one embodiment, a convex rib is arranged on the top board, and the top board presses the convex rib, so that a top edge of the concave portion is lower than a bottom edge of the buckling portion, and the buckling portion is separated from the concave portion.

In one embodiment, when the buckling portion is separated from the concave portion, the rotatable body rotates upward, and an elastic restoring force of the second elastic member enables the conducting base to retreat from the housing.

In one embodiment, the conducting base includes a movable base and an outer housing sleeved over the movable base, the side board is sandwiched between the movable base and the outer housing, and two sides of the outer housing are each concavely provided with a sliding slot along a sliding direction of the conducting base.

In one embodiment, the first elastic member is a linear spring, two sides of the movable base are each upward and concavely provided with a first accommodating slot, the first elastic member is mounted at the first accommodating slot, one end of the first elastic member butts an inner wall surface of the first accommodating slot, and the other end thereof butts the bump.

In one embodiment, the movable base has a main body portion, multiple second terminals are fixed and accommodated in the main body portion, two sides of the main body portion are each extended backward with a side arm, and an inner side of each of the side arms sinks inward to form a guide rail slot.

In one embodiment, the base body includes a base portion and a tongue portion extending forward from the base portion, multiple first terminals are accommodated on the tongue portion, two sides of a front end of the tongue portion are accommodated in the guide rail slot in a sliding manner, and the first terminals electrically contact the second terminals.

In another aspect, the present invention is directed to an electrical connector for electrically connecting a mating plug. In one embodiment, the electrical connector includes: a shell, a conducting base accommodated in the shell in a sliding manner, a rotatable body, and at least one retaining member. The rotatable body is provided with at least one side board. One end of the side board is provided with a pivot used for being pivoted to the conducting base, and the other end of the side board is horizontally connected to a top board. The retaining member presses against the side board. When the conducting base retreats from the shell, the side board rotates relative to the conducting base, so as to drive the retaining member to move upward, stop the conducting base, and prevent the conducting base from retreating to the shell. The top board is located above the conducting base, an insertion space is formed between the top board and the conducting base for the mating plug to be inserted therein, and the mating plug is electrically connected to the conducting base.

In one embodiment, two sides of the conducting base are each provided with a sliding slot along a sliding direction, and the pivot slides in the sliding slot.

In one embodiment, at least one side of the conducting base is provided with a first elastic member, the first elastic member corresponds to the side board and is located at the same side of the conducting base, one end of the side board is provided with a bump located below the center of the pivot, and when the conducting base retreats from the shell, the first elastic member butts the bump to enable the side board to rotate relative to the conducting base.

In one embodiment, the pivot is located at one side of the side board, and the bump is located at the other side of the side board opposite to the one side.

In one embodiment, the pivot is located at one side of the side board, and the bump and the pivot are located at the same side of the side board.

In one embodiment, the side board is convexly provided with a boss in a strip shape, and the boss has a support portion pressing against the retaining member.

In one embodiment, the boss is elliptical, the top of the boss is provided with the support portion, a side of the support portion is an arc surface, and the retaining member presses against the side of the support portion.

In one embodiment, the retaining member is accommodated in the conducting base, one end of the retaining member is provided with a holding portion, the retaining member is provided with a butting portion pressing against the support portion, a side of the retaining member is upward and convexly extended with a stop portion, and when the rotatable body rotates, the boss drives the butting portion to move upward, so that the stop portion ascends and protrudes from an upper surface of the shell, so as to prevent the conducting base from entering the shell.

In one embodiment, a base body is located in the shell, at least one second elastic member is installed between the base body and the conducting base, and the second elastic member provides an elastic force enabling the conducting base to retreat from the shell.

In one embodiment, a buckling portion is convexly arranged on the shell, the top board is correspondingly provided with a concave portion, and when the conducting base is located in the shell, the buckling portion buckles the concave portion to fix the rotatable body.

In one embodiment, when the conducting base is located in the shell, the rotatable body and the conducting base are partially superimposed, and the rotatable body is accommodated in the shell.

In one embodiment, when the conducting base is located in the shell, the pivot is located at a first end of the sliding slot, and when the conducting base retreats from the shell and forms the insertion space with the top board, the pivot slides to a second end of the sliding slot.

In one embodiment, a convex rib is arranged on the top board, and the top board presses the convex rib, so that a top edge of the concave portion is lower than a bottom edge of the buckling portion, and the buckling portion is separated from the concave portion.

In one embodiment, when the buckling portion is separated from the concave portion, the rotatable body rotates upward, and an elastic restoring force of the second elastic member enables the conducting base to retreat from the shell.

In one embodiment, the conducting base includes a movable base and an outer housing sleeved over the movable base, the side board is sandwiched between the movable base and the outer housing, and two sides of the outer housing are each concavely provided with a sliding slot along a sliding direction of the conducting base.

In one embodiment, the first elastic member is a linear spring, two sides of the movable base are each upward and concavely provided with a first accommodating slot, the first elastic member is mounted at the first accommodating slot, one end of the first elastic member butts an inner wall surface of the first accommodating slot, and the other end thereof butts the bump.

In one embodiment, the movable base has a main body portion, multiple second terminals are fixed and accommodated in the main body portion, two sides of the main body portion are each extended backward with a side arm, and an inner side of each of the side arms sinks inward to form a guide rail slot.

In one embodiment, the base body includes a base portion and a tongue portion extending forward from the base portion, multiple first terminals are accommodated on the tongue portion, two sides of a front end of the tongue portion are accommodated in the guide rail slot in a sliding manner, and the first terminals electrically contact the second terminals.

As compared with the related art, the pivot pivoted to the conducting base is arranged on the side board of the electrical connector of the present invention, the side board is provided with the bump off-centered with respect to the pivot, the bump is located below the center of the pivot, the conducting base is provided with the first elastic member, the first elastic member is a linear spring, and the movable base is concavely provided with the first accommodating slot. Only if the first elastic member is mounted at the first accommodating slot to enable one end of the first elastic member to butt the inner wall surface of the first accommodating slot and the other end thereof to butt the bump, installation of the first elastic member may be completed, so the installation process is simple and the operation is easy. When the first elastic member pushes the bump, the rotatable body is restored, the conducting base retreats from the shell, and the top board is located above the conducting base and forms the insertion space with the conducting base. The first elastic member is mounted at the first accommodating slot, so the installation deviation phenomenon is avoided, and therefore the rotatable body can be smoothly opened and form the insertion space with the conducting base, so as to ensure that the conducting base smoothly retreats from the shell to be inserted by the mating plug.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a three-dimensional exploded view of an electrical connector according to one embodiment of the present invention.

FIG. 2 is a three-dimensional exploded view of the electrical connector viewed from another angle according to one embodiment of the present invention.

FIG. 3 is a three-dimensional assembly drawing of an electrical connector according to one embodiment of the present invention.

FIG. 4 is a local sectional view of the electrical connector viewed from the top according to one embodiment of the present invention.

FIG. 5 is a sectional view where a conducting base of the electrical connector completely enters a shell according to one embodiment of the present invention.

FIG. 6 is a local sectional view where a pivot of the electrical connector is located at a first end according to one embodiment of the present invention.

FIG. 7 is a sectional view of FIG. 6 viewed from another angle.

FIG. 8 is a local sectional view where a pivot of the electrical connector is located at a second end according to one embodiment of the present invention.

FIG. 9 is a local sectional view where the electrical connector forms an insertion space according to one embodiment of the present invention.

FIG. 10 is a sectional view of FIG. 9 viewed from another angle.

FIG. 11 is a sectional view where the electrical connector is inserted into a mating plug according to one embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

Additionally, some terms used in this specification are more specifically defined below.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, the terms “comprising”, “including”, “carrying”, “having”, “containing”, “involving”, and the like are to be understood to be open-ended, i.e., to mean including but not limited to.

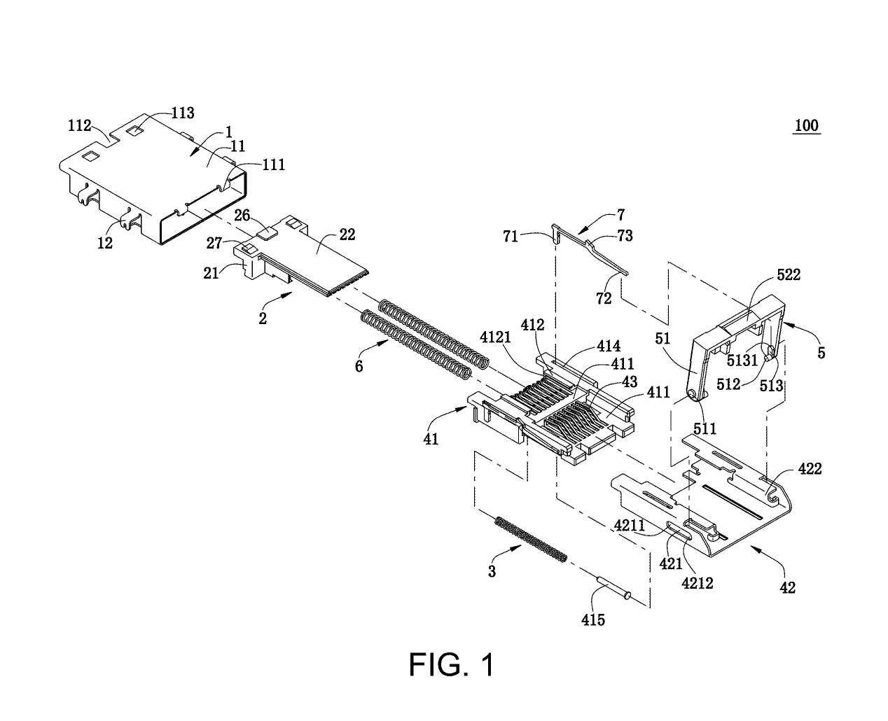

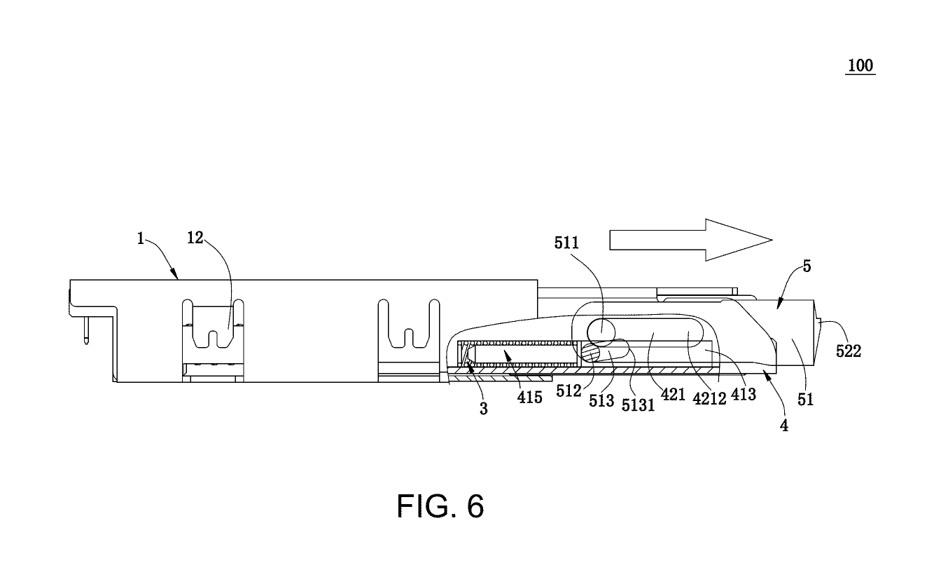

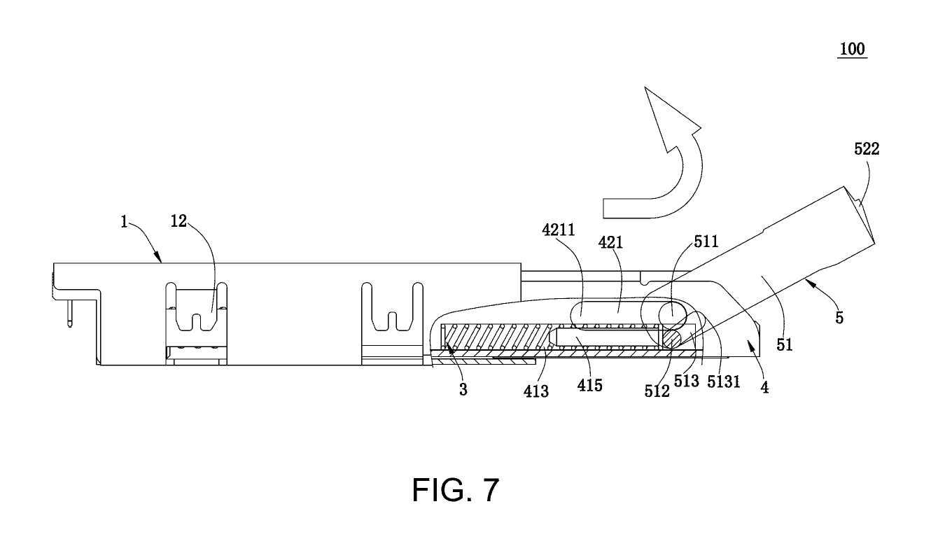

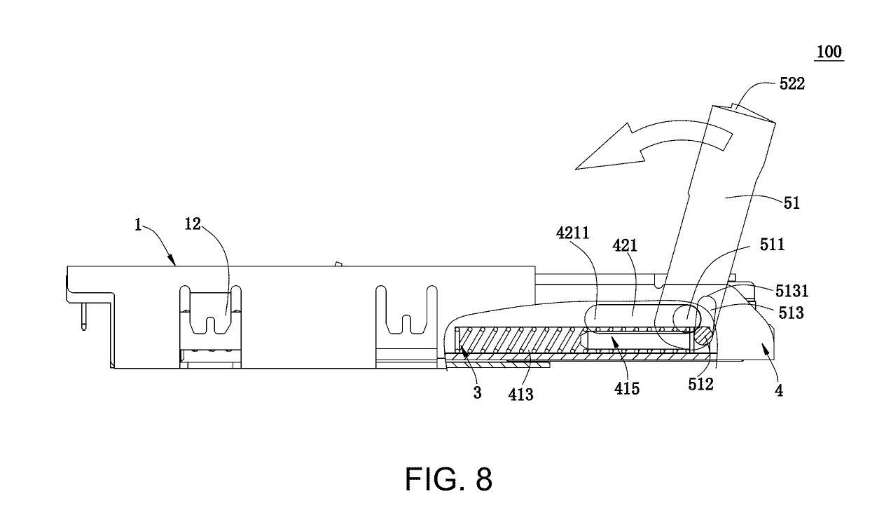

The description will be made as to the embodiments of the present invention in conjunction with the accompanying drawings in FIGS. 1-11. In accordance with the purposes of this invention, as embodied and broadly described herein, this invention, in one aspect, relates to an electrical connector for electrically connecting a mating plug.

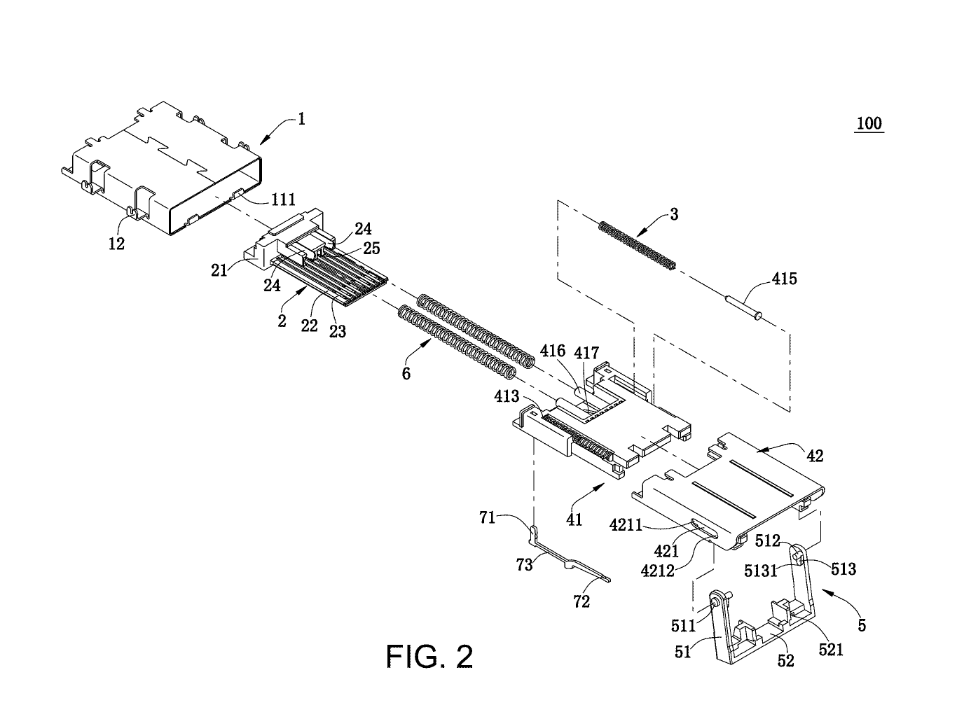

As shown in FIG. 1 and FIG. 2, an electrical connector 100 according to one embodiment of the present invention includes a shell 1, a base body 2, two first elastic members 3, a conducting base 4, a rotatable body 5, two second elastic members 6, and two retaining members 7. The shell 1 wraps the base body 2. The two second elastic members 6 are positioned on the base body 2, and one end of each second elastic member 6 is fixed on the conducting base 4. The conducting base 4 is accommodated in the shell 1 in a sliding manner and may partially extend out of the shell 1. Two sides of the conducting base 4 are each provided with the first elastic member 3. The rotatable body 5 is pivoted onto the conducting base 4. The rotatable body 5 has two bumps 512 pressing against the two first elastic members 3 respectively. The two retaining members 7 are accommodated at the two sides of the conducting base 4 respectively.

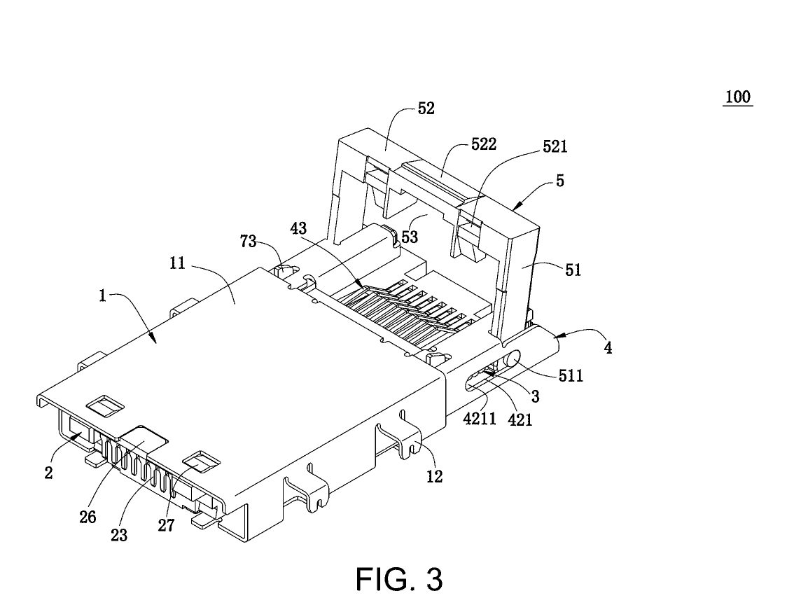

As shown in FIG. 1 and FIG. 3, the shell 1 shields the base body 2. A front end of an upper surface 11 of the shell 1 is downward folded with two buckling portions 111. The two buckling portions 111 are arranged in parallel at an interval, and are used for buckling the rotatable body 5. A back end of the upper surface 11 has an opening 112. Two sides of the opening 112 are each provided with a through slot 113. The two through slots 113 are each at an interval from the opening 112, and are used for locking the base body 2. Two sides of the shell 1 are each provided with two welding feet 12 at an interval, and the welding feet 12 are used for welding and fixing the shell 1 on a mainboard (not shown in the drawing).

As shown in FIG. 1 to FIG. 3, the base body 2 is accommodated in the shell 1. The base body 2 includes a base portion 21 and a tongue portion 22 extending forward from the base portion 21, and multiple first terminals 23 are accommodated on the tongue portion 22 and extend out of the base portion 21. The bottom of the base portion 21 extends in a direction toward the tongue portion 22 and is downward and convexly provided with two limiting portions 24. The two limiting portions 24 are arranged in parallel, and a groove 25 is arranged between the two limiting portions 24. The two second elastic members 6 are installed between the base body 2 and the conducting base 4. The two second elastic members 6 are linear springs, and one end of each of the two second elastic members 6 is correspondingly fixed on each of the two limiting portions 24. Depending on its own elastic restoring force, the second elastic member 6 provides an elastic force enabling the conducting base 4 to retreat from the shell 1. The top of the base portion 21 is upward and convexly provided with a limiting block 26. The limiting block 26 cooperates with the opening 112 to prevent the shell 1 from moving backward. Two sides of the limiting block 26 are each provided with a buckling block 27, and the two buckling blocks 27 correspondingly buckle the two through slots 113 to fix the shell 1.

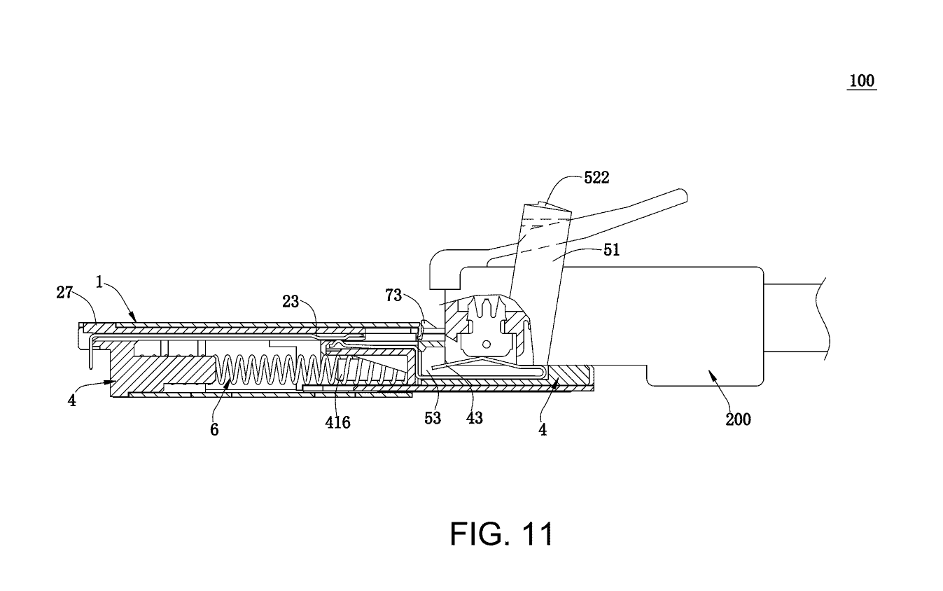

As shown in FIG. 1 to FIG. 4, the conducting base 4 includes a movable base 41 and an outer housing 42 sleeved over the movable base 41. Two sides of the outer housing 42 are each provided with a sliding slot 421 along the sliding direction of the conducting base 4. The sliding slot 421 is elliptical, and has two opposite ends which are a first end 4211 and a second end 4212 respectively. The rotatable body 5 is pivoted into the sliding slot 421, and may slide between the movable base 41 and the outer housing 42. Two sides of the top of the outer housing 42 are each downward folded with a holding sheet 422 held onto the movable base 41. The movable base 41 has a main body portion 411, the holding sheet 422 is held onto the main body portion 411. Multiple second terminals 43 are fixed and accommodated at the main body portion 411. Two sides of the main body portion 411 are each extended backward with a side arm 412 in the same direction. An inner side of each side arms 412 sinks inward to form a guide rail slot 4121. Two sides of a front end of the tongue portion 22 are accommodated in the guide rail slot 4121 in a sliding manner. The second terminal 43 electrically contacts the first terminal 23. One end of the second terminal 43 contacts the first terminal 23, and the other end of the second terminal 43 is electrically connected to a mating plug 200 (as shown in FIG. 11). Two sides of the bottom of the movable base 41 are each upward and concavely provided with a first accommodating slot 413, and each of the first accommodating slots 413 is internally provided with the first elastic member 3, i.e., the first elastic member 3 is mounted in the first accommodating slot 413. The first elastic member 3 is a linear spring. One end of the first elastic member 3 butts an inner wall surface of the first accommodating slot 413, and the other end thereof butts the bump 512. Two first positioning columns 415 are each located in the first accommodating slot 413. Each of the first elastic members 3 is correspondingly sleeved over each of the first positioning columns 415, and used for auxiliarily positioning the first elastic member 3. The first elastic member 3 may extend and retract in the first accommodating slot 413. If the first elastic member 3 is mounted at the first accommodating slot 413 to enable one end of the first elastic member 3 to butt the inner wall surface of the first accommodating slot 413 and the other end thereof to butt the bump 512, installation of the first elastic member 3 can be completed. The first elastic member 3 is a linear spring, so the installation process is simple, and the operation is easy. The first elastic member 3 is mounted at the first accommodating slot 413, so no installation deviation occurs.

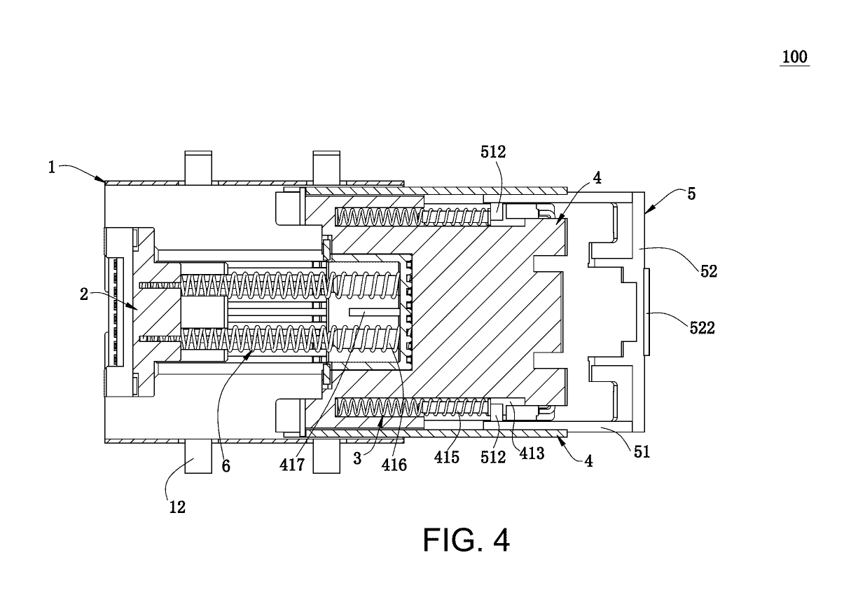

As shown in FIG. 1, FIG. 2 and FIG. 4, two sides of the top of the movable base 41 are each downward and concavely provided with a second accommodating slot 414. Each of the second accommodating slots 414 is internally fixed and accommodated with the retaining member 7, and the retaining member 7 extends out of the second accommodating slot 414. Two second positioning columns 416 are arranged below the movable base 41. One end of each of the two second elastic members 6 is correspondingly fixed onto each of the two limiting portions 24, and the other end of each of the two second elastic members 6 is correspondingly sleeved over each of the two second positioning columns 416. A triangular bump 417 is arranged between the two second positioning columns 416, and when the conducting base 4 is accommodated in the shell 1, the triangular bump 417 enters the groove 25 so as to prevent the conducting base 4 from moving in a direction perpendicular to the sliding direction of the conducting base 4, which causes the second elastic member 6 to be twisted and deformed, and affects the elasticity.

In this embodiment, the first elastic members 3 and the first positioning columns 415 are each two in number, and the second elastic members 6 and the second positioning columns 416 are each two in number. In another embodiment, the first elastic member 3 and the first positioning column 415 are each one in number, the first elastic member 3 and the first positioning column 415 are correspondingly arranged at the same side, and the second elastic member 6 and the second positioning column 416 are each one in number and are correspondingly arranged at the same side.

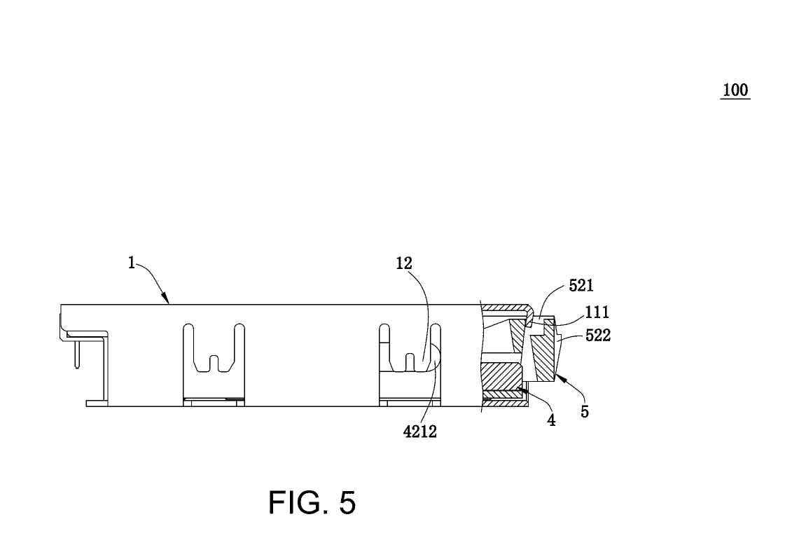

As shown in FIG. 1 to FIG. 3, the rotatable body 5 is pivoted to the conducting base 4, and may slide along the sliding slot 421. The rotatable body 5 has two side boards 51. Each of the side boards 51 is sandwiched between the movable base 41 and the outer housing 42. A top board 52 is bridged between the two side boards 51. The outer side of each of the side boards 51 has a pivot 511 which is respectively pivoted to the sliding slot 421 and can only slide in the sliding slot 421. The inner side of each of the side boards 51 has the bump 512 off-centered with respect to the pivot 511. The bump 512 is located below the center of the pivot 511, and butts the first elastic member 3. The inner side of the side board 51 is convexly provided with a boss 513 in a strip shape which is located below the bump 512. The boss 513 has a support portion 5131 pressing against the retaining member 7. The boss 513 is elliptical. The support portion 5131 is disposed at the top of the boss 513. A side of the support portion 5131 is an arc surface, and the retaining member 7 presses against the side of the support portion 5131. The inner side of the top board 52 has two concave portions 521 corresponding to the two buckling portions 111 on the shell 1. The outer side of the top board 52 has a convex rib 522. As shown in FIG. 3 to FIG. 5, the rotatable body 5 is pressed, and the bump 512 butts the first elastic member 3, so that the pivot 511 is located at the first end 4211, the retaining member 7 does not butt the support portion 5131 anymore, the rotatable body 5 is continuously pushed, and the conducting base 4 presses against the second elastic member 6 to enable the conducting base 4 to enter the shell 1. When the conducting base 4 completely enters the shell 1, i.e., the conducting base 4 is located in the shell 1, the retaining member 7 enters the shell 1 along with the conducting base 4, the buckling portion 111 buckles the concave portion 521 to fix the rotatable body 5, the rotatable body 5 and the conducting base 4 are partially superimposed, the conducting base 4 and the rotatable body 5 are both accommodated in the shell 1, and the bump 512 is located below the pivot 511. As shown in FIG. 5 to FIG. 8, the convex rib 522 is pressed, the first elastic member 3 butts the bump 512, and the side board 51 rotates relative to the conducting base 4, so that the top edge of the concave portion 521 is lower than the bottom edge of the buckling portion 111, the buckling portion 111 is separated from the concave portion 521, the pivot 511 slides to the second end 4212 from the first end 4211, and the rotatable body 5 is opened. Under the action of the second elastic member 6, the conducting base 4 retreats from the shell 1, the side board 51 rotates relative to the conducting base 4, and the boss 513 butts the retaining member 7 so as to drive the retaining member 7 to move upward, stop the conducting base 4, and prevent the conducting base 4 from retreating to the shell 1. The top board 52 is located above the conducting base 4, an insertion space 53 is formed between the top board 52 and the conducting base 4, so as to be inserted by the mating plug 200, and therefore the mating plug 200 is electrically connected to the conducting base 4 (as shown in FIG. 11).

As shown in FIG. 1, FIG. 2 and FIG. 3, in this embodiment, the side boards 51 are two in number. In another embodiment, the side board 51 may be one in number, is corresponding to the first elastic member 3 and is located at the same side of the conducting base 4. One end of the side board 51 is pivoted to the sliding slot 421 and the other end of the side board 51 is horizontally connected to a top board 52. In this embodiment, the pivot 511 is located at the outer side of the side board 51, and the bump 512 is located at the inner side of the side board 51, i.e., the pivot 511 is located at one side of the side board 51, and the bump 512 is located at the other side of the side board 51 opposite to the one side. In another embodiment, the pivot 511 may be located at the outer side or inner side of the side board 51, and the bump 512 may also be located at the outer side or inner side of the side board 51, i.e., the bump 512 may be located at the same side of the side board 51 with the pivot 511.

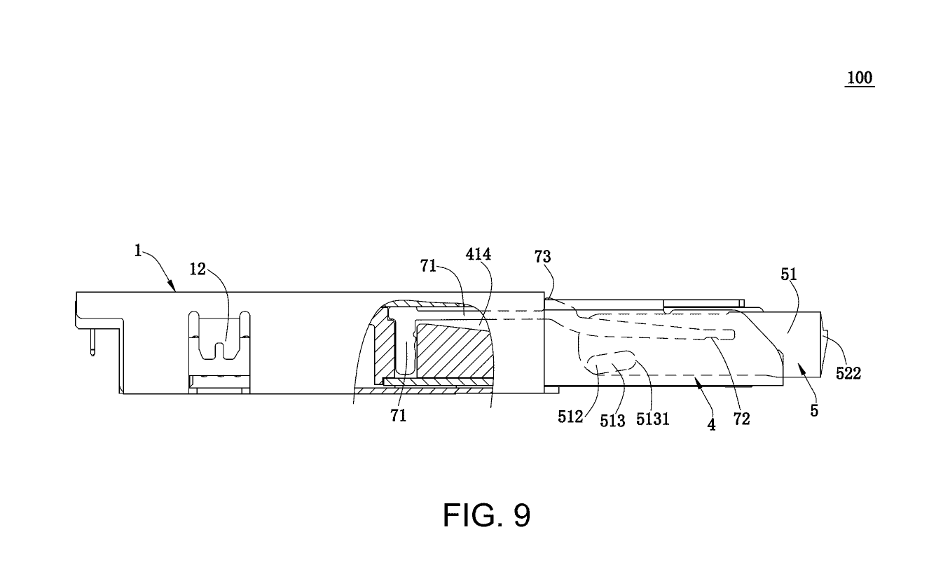

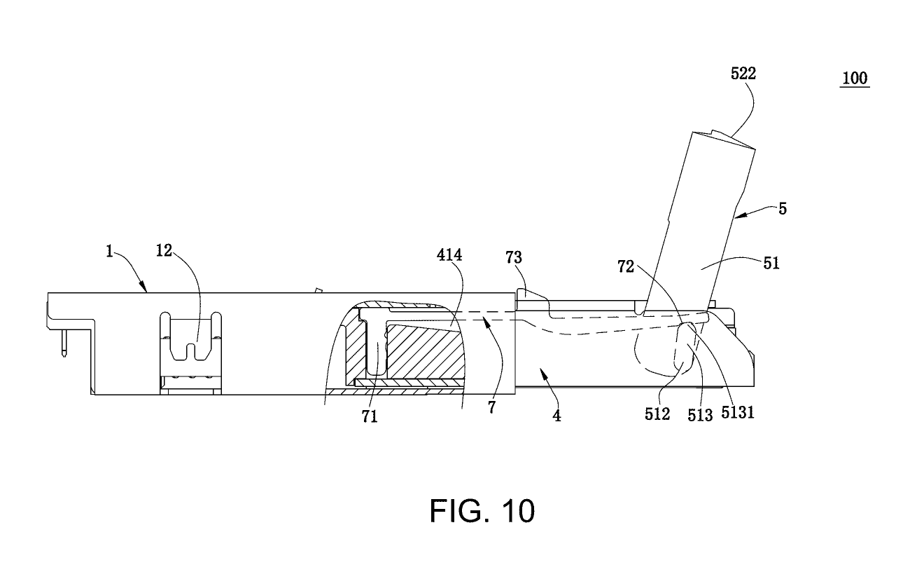

As shown in FIG. 1, FIG. 9 and FIG. 10, the two retaining members 7 are accommodated in the second accommodating slot 414. One end of each of the retaining members 7 has a holding portion 71 fixed on the movable base 41, and the other end of each of the retaining members 7 has a butting portion 72 pressing against the support portion 5131. In this embodiment, the butting portion 72 is arranged at the other end of the retaining member 7, and in another embodiment, the butting portion 72 may also be arranged at an intermediate location of the retaining member 7. A side of each of the retaining members 7 is upward and convexly extended with a stop portion 73. When the convex rib 522 is pressed, the rotatable body 5 rotates, the boss 513 butts the retaining member 7 so that the boss 513 drives the butting portion 72 to move upward, and therefore the stop portion 73 ascends and protrudes from the upper surface 11, so as to stop the conducting base 4, and prevent the conducting base 4 from entering the shell 1. When the rotatable body 5 is pulled to enable the conducting base 4 to enter the shell 1, the rotatable body 5 rotates, the boss 513 does not butt the butting portion 72 anymore, the butting portion 72 moves downward, and the stop portion 73 descends to a location lower than the upper surface 11, so the stop portion 73 does not prevent the conducting base 4 from entering the shell 1 anymore, and the retaining member 7 enters the shell 1 and is accommodated in the shell 1 along with the conducting base 4. In this embodiment, the retaining members 7 are two in number, and in another embodiment, the retaining member 7 may be one in number.

As shown in FIG. 1 to FIG. 5, when the electrical connector 100 is assembled, firstly the second terminal 43 is assembled onto the movable base 41. Then the first elastic member 3 sleeved with the first positioning column 415 is correspondingly assembled onto the first accommodating slot 413. The two second positioning columns 416 are installed below the movable base 41. The second elastic member 6 is sleeved over the second positioning column 416. The two retaining members 7 are correspondingly assembled onto the two second accommodating slots 414, and the holding portion 71 is held in the second accommodating slot 414. Further the outer housing 42 is sleeved over the movable base 41. The holding sheet 422 is held onto the main body portion 411, so that the outer housing 42 is fixed onto the movable base 41. The movable base 41 and the outer housing 42 are combined into the conducting base 4. Furthermore the rotatable body 5 is installed onto the conducting base 4. The side board 51 is sandwiched between the movable base 41 and the outer housing 42, the pivot 511 is respectively pivoted in the sliding slot 421 and may slide in the sliding slot 421, the bump 512 butts the first elastic member 3, the support portion 5131 of the boss 513 presses against the butting portion 72 of the retaining member 7, and the top board 52 is located above the conducting base 4. Then the first terminal 23 is assembled onto the base body 2. One end of each of the two second elastic members 6 is correspondingly fixed onto each of the two limiting portions 24, and the front end of the tongue portion 22 enters the guide rail slot 4121 in a sliding manner. Moreover, the triangular bump 417 enters the groove 25 and is finally fixed, and the first terminal 23 contacts the second terminal 43. Finally the shell 1 is assembled to the base body 2 from front to rear, and the conducting base 4 is partially exposed from the shell 1. The stop portion 73 protrudes from the upper surface 11, the limiting block 26 enters the opening 112 and cooperates with the opening 112 to prevent the shell 1 from moving backward, the two buckling blocks 27 correspondingly buckle the two through slots 113 to fix the shell 1, and the rotatable body 5 is pushed so that the conducting base 4 completely enters the shell 1. The stop portion 73 descends to a location lower than the upper surface 11 and enters the shell 1, the buckling portion 111 buckles the concave portion 521 thereby fixing the rotatable body 5, the retaining member 7 and the side board 51 are accommodated in the shell 1, and the welding foot 12 is welded and fixed on the mainboard (not shown).

As shown in FIG. 5 to FIG. 8, when it is required to open the rotatable body 5 and insert the mating plug 200, the convex rib 522 is pressed, the first elastic member 3 butts the bump 512, and the side board 51 rotates relative to the conducting base 4, so that the top edge of the concave portion 521 is lower than the bottom edge of the buckling portion 111, and the buckling portion 111 is separated from the concave portion 521. Under the action of the second elastic member 6, the conducting base 4 retreats from the shell 1, and while the side board 51 rotates relative to the conducting base 4, the boss 513 butts the butting portion 72 so that the boss 513 drives the butting portion 72 to move upward, and therefore the stop portion 73 ascends and protrudes from the upper surface of the shell 1, the stop portion 73 is stopped at an edge of the upper surface 11 of the shell 1, so as to prevent the conducting base 4 from rebounding to the shell 1 (as shown in FIG. 10). The elastic restoring force of the first elastic member 3 enables the first elastic member 3 to extend to push the bump 512, so that the pivot 511 slides to the second end 4212 from the first end 4211 of the sliding slot 421. The first elastic member 3 continues to extend to push the bump 512, the pivot 511 is limited by the second end 4212 and cannot slide anymore, and the side board 51 rotates relative to the conducting base 4 around the pivot 511, so that the top board 52 is located above the conducting base 4, and the insertion space 53 is formed between the top board 52 and the conducting base 4, so as to be inserted by the mating plug 200 (as shown in FIG. 11). In this case, the first elastic member 3 is limited by its own length and elasticity and stops extending. The mating plug 200 is inserted, and the mating plug 200 is electrically connected to the second terminal 43. The stop portion 73 is stopped at the edge of the upper surface 11 of the shell 1, so the conducting base 4 does not enter the shell 1 due to insertion of the mating plug 200 (as shown in FIG. 11).

As shown in FIG. 3 to FIG. 5, when it is not required to insert the mating plug 200, but it is required to collapse the rotatable body 5, firstly the mating plug 200 is unplugged (as shown in FIG. 11). The rotatable body 5 is pulled, the boss 513 does not butt the butting portion 72 anymore, the butting portion 72 moves downward, and the stop portion 73 descends. When the rotatable body 5 rotates to be in parallel with the conducting base 4, the stop portion 73 descends to a location lower than the upper surface 11 of the shell 1, and does not prevent the conducting base 4 from entering the shell 1 anymore, and the bump 512 pushes to compress the first elastic member 3. The rotatable body 5 is pushed, so that the pivot 511 slides to the first end 4211 from the second end 4212. The rotatable body 5 is accommodated in the conducting base 4, and the bump 512 further pushes to compress the first elastic member 3. The rotatable body 5 continues to be pushed, so that the pivot 511 butts the sliding slot 421, and the second elastic member 6 begins to be compressed so that the conducting base 4 enters the shell 1. The stop portion 73 descends to a location lower than the upper surface of the shell 1, does not prevent the conducting base 4 from entering the shell 1 anymore (as shown in FIG. 9), and enters the shell 1 along with the conducting base 4, and the rotatable body 5 is further pushed so the conducting base 4 completely enters the shell 1, i.e., the conducting base 4 is located in the shell 1. The buckling portion 111 buckles the concave portion 521 to fix the rotatable body 5 and prevent the conducting base 4 from bouncing out of the shell 1, and the conducting base 4 and the rotatable body 5 are both accommodated in the shell 1, thereby collapsing the electrical connector 100. The rotatable body 5 is firstly accommodated to the conducting base 4, and the conducting base 4 is then accommodated in the shell 1, thereby shortening the whole length of the electrical connector 100, so the volume of the electrical connector 100 is reduced, and the occupied space is saved.

In summary, the electrical connector 100 according to certain embodiments of the present invention, among other things, has the following beneficial advantages.

1. The pivot 511 arranged on the side board 51 is pivoted to the conducting base 4, the side board 51 is provided with the bump 512 off-centered with respect to the pivot 511, the bump 512 is located below the center of the pivot 511, the conducting base 4 is provided with the first elastic member 3, the first elastic member 3 is a linear spring, the movable base 41 is concavely provided with the first accommodating slot 413, and only if the first elastic member 3 is mounted at the first accommodating slot 413 to enable one end of the first elastic member 3 to butt the inner wall surface of the first accommodating slot 413 and the other end thereof to butt the bump 512, installation of the first elastic member 3 may be completed, so the installation process is simple, and the operation is easy. When the first elastic member 3 pushes the bump 512, the rotatable body 5 is restored, the conducting base 4 retreats from the shell 1, and the top board 52 is located above the conducting base 4 and forms the insertion space 53 with the conducting base 4. The first elastic member 3 is mounted at the first accommodating slot 413, so the installation deviation is avoided, and therefore the rotatable body 5 can be smoothly opened and form the insertion space 53 with the conducting base 4, so as to ensure that the conducting base 4 smoothly retreats from the shell 1 to be inserted by the mating plug 200.

2. The pivot 511 arranged on the side board 51 is pivoted to the conducting base 4, the side board 51 is provided with the bump 512 off-centered with respect to the pivot 511, the bump 512 is located below the center of the pivot 511, and the conducting base 4 is provided with the first elastic member 3 butting the bump 512. When the conducting base 4 retreats from the shell 1, the first elastic member 3 pushes the bump 512, and the rotatable body 5 extends out of the conducting base 4 and automatically rotates, so that the top board 52 is located above the conducting base 4 and forms the insertion space 53 with the conducting base 4. The operation may be completed in one step, and the operation step may be simplified.

3. One end of the retaining member 7 is provided with the holding portion 71 fixed on the conducting base 4, the other end of the retaining member 7 is provided with the butting portion 72 pressing against the support portion 5131, and the boss 513 drives the butting portion 72 to move upward, so that the stop portion 73 ascends and protrudes from the upper surface of the shell 1, so as to stop the conducting base 4 and prevent the conducting base 4 from entering the shell 1. The retaining member 7 is simple in structure and convenient for operation, and the conducting base 4 does not enter the shell 1 due to insertion of the mating plug 200.

4. For collapsing the electrical connector 100, firstly the rotatable body 5 pivoted to the conducting base 4 is pushed, so that the rotatable body 5 rotates and is accommodated into the conducting base 4 in a sliding manner along the sliding slot 421.

The rotatable body 5 continues to be pushed to enable the conducting base 4 to slide into the shell 1, so that the buckling portion 111 buckles the concave portion 521 to fix the rotatable body 5 and prevent the conducting base 4 from bouncing out of the shell 1. The rotatable body 5 is firstly accommodated to the conducting base 4, and the conducting base 4 is then accommodated in the shell 1, thereby shortening the whole length of the electrical connector 100, so that the volume of the electrical connector 100 is reduced, and the occupied space is saved.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector for electrically connecting a mating plug, comprising:
a shell;
a conducting base, accommodated in the shell in a sliding manner, wherein at least one side of the conducting base is provided with a first elastic member; and
a rotatable body, having at least one side board corresponding to the first elastic member and located at the same side of the conducting base with the first elastic member, wherein the side board comprises a pivot for being pivoted to the conducting base, one end of the side board is disposed with a bump located below the center of the pivot, so that the first elastic member butts the bump, and the other end of the side board is horizontally connected to a top board,
wherein when the conducting base retreats from the shell, the first elastic member butts the bump, so that the side board rotates relative to the conducting base, the top board is located above the conducting base, an insertion space is formed between the top board and the conducting base, for the mating plug to be inserted therein and electrically connected to the conducting base.

2. The electrical connector according to claim 1, wherein the pivot is located at one side of the side board, and the bump is located at the other side of the side board opposite to the one side.

3. The electrical connector according to claim 1, wherein the pivot is located at one side of the side board, and the bump and the pivot are located at the same side of the side board.

4. The electrical connector according to claim 1, wherein when the conducting base is located in the shell, the rotatable body and the conducting base are partially superimposed, and the rotatable body is accommodated in the shell.

5. The electrical connector according to claim 1, wherein a buckling portion is convexly arranged on the shell, the top board is correspondingly provided with a concave portion, and when the conducting base is located in the shell, the buckling portion buckles the concave portion to fix the rotatable body.

6. The electrical connector according to claim 5, wherein a convex rib is arranged on the top board, and the top board presses the convex rib, so that a top edge of the concave portion is lower than a bottom edge of the buckling portion, and the buckling portion is separated from the concave portion.

7. The electrical connector according to claim 6, wherein when the buckling portion is separated from the concave portion, the rotatable body rotates upward, and an elastic restoring force of the second elastic member enables the conducting base to retreat from the shell.

8. The electrical connector according to claim 1, wherein two sides of the conducting base are each provided with a sliding slot along a sliding direction, and the pivot slides in the sliding slot.

9. The electrical connector according to claim 8, wherein when the conducting base is located in the shell, the pivot is located at a first end of the sliding slot, and when the conducting base retreats from the shell and forms the insertion space with the top board, the pivot slides to a second end of the sliding slot.

10. The electrical connector according to claim 8, wherein a base body is accommodated in the shell, at least one second elastic member is installed between the base body and the conducting base, and the second elastic member provides an elastic force enabling the conducting base to retreat from the shell.

11. The electrical connector according to claim 10, wherein the conducting base comprises a movable base and an outer housing sleeved over the movable base, the side board is sandwiched between the movable base and the outer housing, and two sides of the outer housing are each concavely provided with the sliding slot along a sliding direction of the conducting base.

12. The electrical connector according to claim 11, wherein the first elastic member is a linear spring, two sides of the movable base are each upward and concavely provided with a first accommodating slot, the first elastic member is mounted at the first accommodating slot, one end of the first elastic member butts an inner wall surface of the first accommodating slot, and the other end thereof butts the bump.

13. The electrical connector according to claim 11, wherein the movable base has a main body portion, multiple second terminals are fixed and accommodated in the main body portion, two sides of the main body portion are each extended backward with a side arm, and an inner side of each of the side arms sinks inward to form a guide rail slot.

14. The electrical connector according to claim 13, wherein the base body comprises a base portion and a tongue portion extending forward from the base portion, multiple first terminals are accommodated on the tongue portion, two sides of a front end of the tongue portion are accommodated in the guide rail slot in a sliding manner, and the first terminals electrically contact the second terminals.

15. An electrical connector for electrically connecting with a mating plug, comprising:
a shell;
a conducting base, accommodated in the shell in a sliding manner;
a rotatable body, having at least one side board, wherein one end of the side board comprises a pivot for being pivoted to the conducting base, and the other end of the side board is horizontally connected to a top board; and
at least one retaining member pressing against the side board,
wherein when the conducting base retreats from the shell, the side board rotates relative to the conducting base, so as to drive the retaining member to move upward, stop the conducting base, and prevent the conducting base from retreating to the shell, the top board is located above the conducting base, an insertion space is formed between the top board and the conducting base, for the mating plug to be inserted therein and electrically connected to the conducting base.

16. The electrical connector according to claim 15, wherein two sides of the conducting base are each provided with a sliding slot along a sliding direction, and the pivot slides in the sliding slot.

17. The electrical connector according to claim 16, wherein when the conducting base is located in the shell, the pivot is located at a first end of the sliding slot, and when the conducting base retreats from the shell and forms the insertion space with the top board, the pivot slides to a second end of the sliding slot.

18. The electrical connector according to claim 15, wherein at least one side of the conducting base is provided with a first elastic member corresponding to the side board and located at the same side of the conducting base with the side board, one end of the side board comprises a bump located below the center of the pivot, and when the conducting base retreats from the shell, the first elastic member butts the bump to enable the side board to rotate relative to the conducting base.

19. The electrical connector according to claim 18, wherein the pivot is located at one side of the side board, and the bump is located at the other side of the side board opposite to the one side.

20. The electrical connector according to claim 18, wherein the pivot is located at one side of the side board, and the bump and the pivot are located at the same side of the side board.

21. The electrical connector according to claim 15, wherein the side board is convexly provided with a boss in a strip shape, and the boss has a support portion pressing against the retaining member.

22. The electrical connector according to claim 21, wherein the boss is elliptical, the top of the boss is provided with the support portion, a side of the support portion is an arc surface, and the retaining member presses against the side of the support portion.

23. The electrical connector according to claim 21, wherein the retaining member is accommodated in the conducting base, one end of the retaining member is provided with a holding portion, the retaining member is provided with a butting portion pressing against the support portion, a side of the retaining member is upward and convexly extended with a stop portion, and when the rotatable body rotates, the boss drives the butting portion to move upward, so that the stop portion ascends and protrudes from an upper surface of the shell, so as to prevent the conducting base from entering the shell.

24. The electrical connector according to claim 15, wherein a buckling portion is convexly arranged on the shell, the top board is correspondingly provided with a concave portion, and when the conducting base is located in the shell, the buckling portion buckles the concave portion to fix the rotatable body.

25. The electrical connector according to claim 24, wherein a convex rib is arranged on the top board, and the top board presses the convex rib, so that a top edge of the concave portion is lower than a bottom edge of the buckling portion, and the buckling portion is separated from the concave portion.

26. The electrical connector according to claim 25, wherein when the buckling portion is separated from the concave portion, the rotatable body rotates upward, and an elastic restoring force of the second elastic member enables the conducting base to retreat from the shell.

27. The electrical connector according to claim 15, wherein when the conducting base is located in the shell, the rotatable body and the conducting base are partially superimposed, and the rotatable body is accommodated in the shell.

28. The electrical connector according to claim 15, wherein a base body is located in the shell, at least one second elastic member is installed between the base body and the conducting base, and the second elastic member provides an elastic force enabling the conducting base to retreat from the shell.

29. The electrical connector according to claim 28, wherein the conducting base comprises a movable base and an outer housing sleeved over the movable base, the side board is sandwiched between the movable base and the outer housing, and two sides of the outer housing are each concavely provided with a sliding slot along a sliding direction of the conducting base.

30. The electrical connector according to claim 29, wherein the first elastic member is a linear spring, two sides of the movable base are each upward and concavely provided with a first accommodating slot, the first elastic member is mounted at the first accommodating slot, one end of the first elastic member butts an inner wall surface of the first accommodating slot, and the other end thereof butts the bump.

31. The electrical connector according to claim 29, wherein the movable base has a main body portion, multiple second terminals are fixed and accommodated in the main body portion, two sides of the main body portion are each extended backward with a side arm, and an inner side of each of the side arms sinks inward to form a guide rail slot.

32. The electrical connector according to claim 31, wherein the base body comprises a base portion and a tongue portion extending forward from the base portion, multiple first terminals are accommodated on the tongue portion, two sides of a front end of the tongue portion are accommodated in the guide rail slot in a sliding manner, and the first terminals electrically contact the second terminals.
